(19) United States
(12) Patent Application Publication
(10) Pub. No.: US 2025/0197746 A1
(43) Pub. Date: Jun. 19, 2025

(54) METHOD AND SYSTEM FOR GENERATING SYNGAS

(71) Applicant: GREEN ENERGY INVESTMENT HOLDING PTE LTD, SINGAPORE (SG)

(72) Inventor: SHAO LIN LIM, SINGAPORE (SG)

(73) Assignee: GREEN ENERGY INVESTMENT HOLDING PTE LTD, SINGAORE (SG)

(21) Appl. No.: 18/574,207

(22) PCT Filed: Dec. 17, 2023
(86) PCT No.: PCT/SG2023/050843

§ 371 Date: Dec. 26, 2023

(51) Int. Cl. C10J 3/00; B01J 6/00; B01J 19/00; B01J 19/20; B01J 19/24; C01B 3/02

(52) U.S. Cl. CPC C10J 3/007; B01J 6/008; B01J 19/0013; B01J 19/20; B01J 19/2435; C01B 3/02; B01J 2219/00074; B01J 2219/00135; C10J 2200/158; C10J 2300/092

(57) ABSTRACT

A method for generating syngas comprising heating cellulosic material in a vessel comprising a pathway and a heat generator in thermal communication with the pathway to thermally degenerate the cellulosic material by pyrolysis, the cellulosic material forming biochar and releasing syngas when undergoing pyrolysis, displacing the generated syngas along the pathway to thereby filter the syngas through at least one of the cellulosic material and the biochar undergoing pyrolysis, reacting at least a portion of the generated syngas with catalytic material presented along the pathway for reforming the at least a portion of the generated syngas being displaced along the pathway, and discharging the filtered syngas from the vessel. The cellulosic material comprising at least one of woodchips, wood pellets, biomass and biowaste.

### TECHNICAL FIELD

This invention relates generally to a method and system for generating syngas.

### BACKGROUND

Low density agricultural biomass, for example bark and wood chips, is typically widely dispersed within a given geographical area, difficult to collect and expensive to transport economically. In the fast pyrolysis of low-density agricultural biomass, a common problem that makes the process uneconomical is the prohibitive cost of transporting these bulky materials to a central processing site. Such materials therefore rely upon a significant reduction or elimination of these material transportation costs. It would be desirable to provide self-contained fast pyrolysis process equipment that is compact, mobile and has the ability to be set up and operated close to the source of the feed materials. To make it easier for farmers and workmen, particularly in the developing world, to take advantage of such mobile equipment, it would also be desirable that the equipment be simple to operate and flexible in terms of the choice of fuel source. The process employed in using the equipment should be forgiving in terms of particle size and biomass moisture content. The process should also take advantage of rapid heat transfer and short solids residence time to reduce vessel size and increase throughput.

To date, conventional fast pyrolysis processes employ multiple vessels, are complex to operate, are inflexible and/or are not suitable for mobile operation. Compact systems that combine the combustion chamber and pyrolysis reactor in a single vessel usually involve mixing of fluids and/or solids between the two portions of the vessel; this leads to contamination and/or destruction of the most valuable condensable liquid products in the product gas. The need therefore exists for an improved apparatus for pyrolysis of low-density agricultural biomass and a process for use thereof.

Combustible gases can be generated by thermo-chemical conversion of biomass. Biomass may be any suitable carbon-containing fuel. Non-limiting examples of biomass include: wood in any suitable such as sawdust, shavings, pellets, cellulosic material and other wood residue, municipal waste, sewage, coal, bitumen, fossil fuels, food waste and plant matter. Combustible gases may be liberated from biomass by heating the biomass in an oxygen-reduced atmosphere. The heating may be done by partially oxidizing the biomass or by way of a separate heat source. The heating causes the biomass to release combustible gases which are also known as “syngas”, “synthesis gas”, “producer gas” and “product gas”.

Syngas produced from biomass may be used for various applications. For example, the gases may be burned to generate heat, processed to make synthetic fuels (the synthetic fuels may comprise gaseous, liquid or solid fuels), used to run an engine, used as a fuel for a fuel cell or used as a fuel to run a turbine. Syngas liberated from biomass may include fractions, such as tars and heavier hydrocarbons, that can condense in ducts and other equipment. This can cause significant operational and maintenance problems. As such, the yield increment of useful constituents of syngas, for example hydrogen, is also impeded. There is a need for practical and energy-efficient methods and apparatus for producing clean syngas from biomass, specifically from cellulosic material

### SUMMARY

In accordance with a first aspect of the invention, there is disclosed a method for generating syngas comprising heating cellulosic material in a vessel comprising a pathway and a heat generator in thermal communication with the pathway to thermally degenerate the cellulosic material by pyrolysis, the cellulosic material forming biochar and releasing syngas when undergoing pyrolysis, displacing the generated syngas along the pathway to thereby filter the syngas through at least one of the cellulosic material and the biochar undergoing pyrolysis, reacting at least a portion of the generated syngas with catalytic material presented along the pathway for reforming the at least a portion of the generated syngas being displaced along the pathway, and discharging the filtered syngas from the vessel. The cellulosic material comprising at least one of woodchips, wood pellets, biomass and biowaste.

In accordance with a second aspect of the invention, there is disclosed a system for generating syngas comprising a vessel comprising a pathway for heating cellulosic material therein, and a heat generator in thermal communication with the pathway to thermally degenerate the cellulosic material by pyrolysis, the cellulosic material forming biochar and releasing syngas when undergoing pyrolysis. The pathway is shaped and adapted for displacing the generated syngas along the pathway to thereby filter the syngas through at least one of the cellulosic material and the biochar undergoing pyrolysis and the pathway having catalytic material presented therealong for reacting with at least a portion of the generated syngas to reform the at least a portion of the generated syngas being circulated along the pathway. The filtered syngas is dischargeable from the vessel, and the cellulosic material comprising at least one of woodchips, wood pellets, biomass and biowaste.

### BRIEF DESCRIPTION OF THE DRAWINGS

FIG. 1 shows an exemplary process flow diagram of a method for generating syngas in accordance with an aspect of the invention;

FIG. 2 shows an exemplary system diagram of a system for generating syngas of FIG. 1 comprising a vessel and a pathway with syngas being displaced substantially against the flow of cellulosic material along the pathway being formed with catalytic material;

FIG. 3 shows an exemplary system diagram of the system for generating syngas of FIG. 2 for further processing of the syngas discharged from the vessel;

FIG. 4 shows an exemplary system diagram of the system for generating syngas of FIG. 1 with the pathway being formed with a closed-loop circuit; and

FIG. 5 shows an exemplary system diagram of the system for generating syngas of FIG. 1 with a screw auger forming a conveyor system.

### DETAILED DESCRIPTION

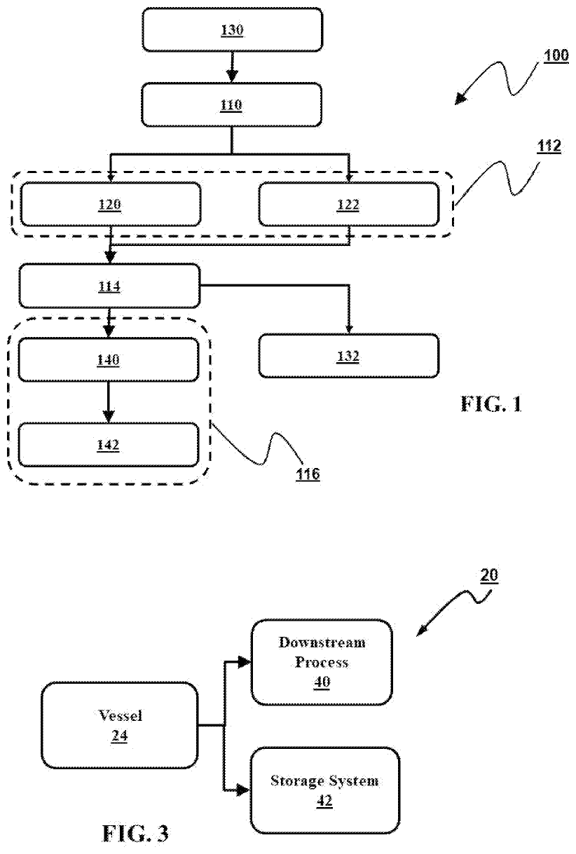

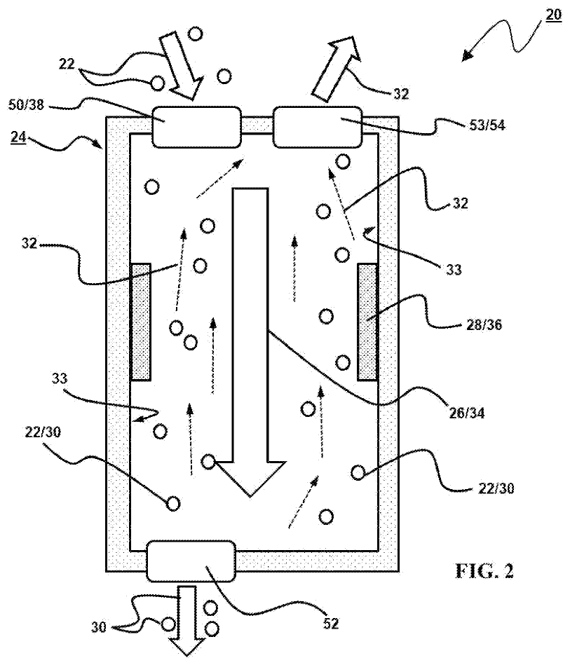

An exemplary embodiment of the present invention, a method for generating syngas 100 (“syngas method 100”), implementable with a system for generating syngas 20 (“syngas system 20”), is described hereinafter with reference to FIG. 1 to FIG. 5. The syngas method 100 comprises a step 110 of heating cellulosic material 22 in a vessel 24 comprising a pathway 26 and a heat generator 28 in thermal communication with the pathway 26 to thermally degenerate the cellulosic material 22 by pyrolysis. The cellulosic material 22 is for forming biochar 30 and for releasing syngas 32 when undergoing pyrolysis. The syngas method 100 further comprises a step 112 of displacing the generated syngas 32 along the pathway 26 to thereby filter the syngas 32 through at least one of the cellulosic material 22 and the biochar 30 undergoing pyrolysis, and a step 114 of reacting at least a portion of the generated syngas 32 with catalytic material 33 presented along the pathway 26 for reforming the at least a portion of the generated syngas 32 being displaced along the pathway 26. The syngas method 100 further comprises a step 116 of discharging the filtered syngas 32 from the vessel 24. As the syngas 32 is generated together with tar, soot and the like impurities, the cellulosic material 22, in whichever stage of pyrolysis, will act to function as a filter medium to remove, trap or scrub the impurities from the syngas 32 to thereby clean the syngas 32. The vessel 24 and the catalytic material 33 are constituents of the syngas system 20. Preferably, the cellulosic material 22 comprises at least one of woodchips, wood pellets, biomass and biowaste. An example of the at least one of woodchips and wood pellets is woody biomass. Examples of biowaste includes food waste, plant fibre, agricultural biomass and the like cellulose-containing and hemicellulose-containing materials and articles.

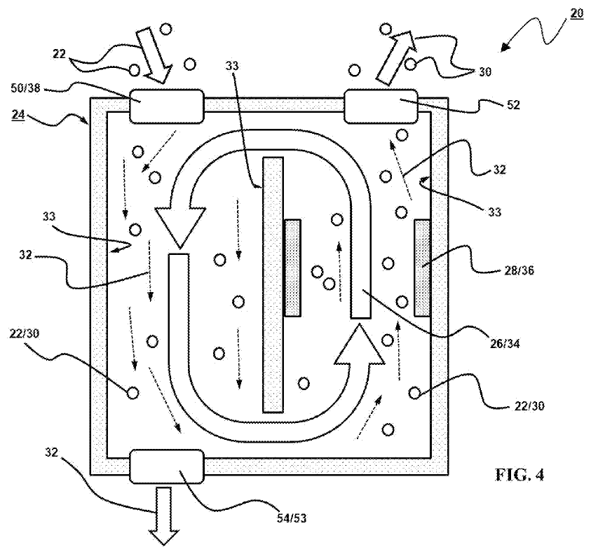

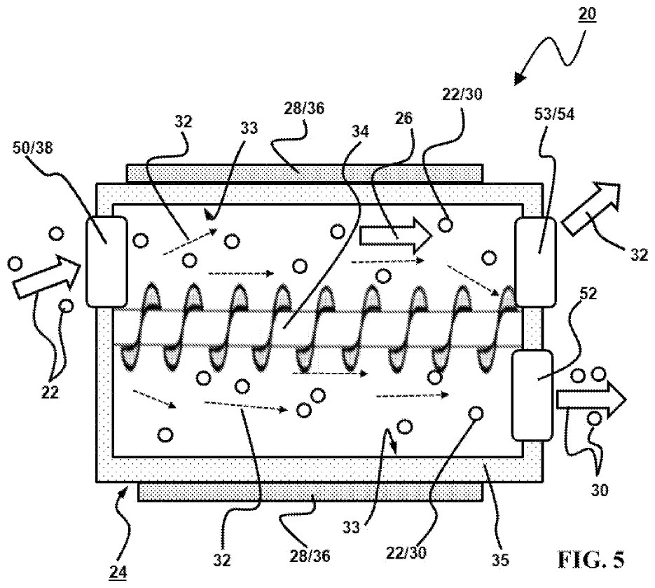

Preferably, when in use, the pathway 26 is for displacing the cellulosic material 22, at different stages of charring, across the heat generator 28 and to displace the generated syngas 32 through at least one of the cellulosic material 22 and the biochar 30 undergoing pyrolysis. Preferably, the vessel 24 is a pressure vessel made from heat resistant and high strength material such as steel. Further, the heat generator 28 is capable of generating heat at and beyond 400 degrees celsius. Further preferably, the heat generator 28 is capable of generating heat at and beyond 900 degrees Celsius to achieve flash pyrolysis of the cellulosic material 22, for example flash vacuum pyrolysis. The pathway 26 comprises a closed-loop circuit for recirculating the syngas for filtering through at least one of the cellulosic material 22 and the biochar, as illustrated in FIG. 4. The pathway 26 may be formed from one or more passageways (not shown).

In one implementation of the syngas method 100, the vessel 24 comprises at least one tube 35 for forming the pathway 26. The at least one tube 35 can be a pipe having a substantially cylindrical construction with an internal space which, in this case, forms the pathway 26. In this implementation, the at least one of tube 35 is internally-coated with the catalytic material 33 for exposing the generated syngas 32 thereto during passage of the syngas through the pathway 26.

In another implementation, the vessel 24 also comprises the at least one tube 35 for forming the pathway 26. In this implementation, the at least one of tube is one of substantial and entirely formed from the catalytic material 33 for exposing the generated syngas 32 thereto during passage of the syngas through the pathway 26. With the at least one tube 25 being formed from the catalytic material 33, the inside or internal surface of the tube 35 will naturally be presenting the catalytic material 33 to the generated syngas.

The catalytic material 33 is preferably formed from at least one of Nickle (Ni), Molybdenum (Mo), Platinum (Pt), Ruthenium (Ru), Cobalt/Molybdenum (CoMo), Nickel/Molybdenum (NiMo) and Nickle Oxide (NiO) catalysts. In various implementations, t is preferred that the catalytic material 33 have a high Ni content.

Preferably, the step 112 of displacing the generated syngas 32 along the pathway 26 comprises a step 120 of displacing the cellulosic material 22 along the pathway 26 by a conveyor system 34, for example a screw conveyor system, for heating by the heat generator 28 for forming the biochar 30. It is preferred that at least a portion or substantially all surfaces of the conveyors system 34 that comes into contact with the syngas 32 is formed with, including coated with, the catalytic material 33. Alternatively, the conveyor system 34 may partially or completely rely on gravity feeding of the cellulosic material 22 along the pathway 26 for pyrolysis, or flash pyrolysis, thereof. However, it is preferred that the conveyor system 34 is a screw auger having the catalytic material 33 coated thereon. The step 112 of displacing the generated syngas 32 along the pathway 26 may further comprise a step 122 of displacing the generated syngas 32 by a displacement system 36 along the pathway 26 and substantially through the cellulosic material 22 undergoing pyrolysis. The cellulosic material 22 are preferably pre-heated before being introduced into the vessel 24. The displacement system 36 can be, for example, an air blower or through the use of coanda effect/flow configuration. In one implementation, the displacement system 36 may be form integral with the heat generator 28.

In one implementation with the conveyor system 34 being the screw auger, the vessel 24 is substantially functioning as an auger pyrolyser with the heat generator 28 being disposed on the external surface of the at least one tube 35 as shown in FIG. 5. By having internal surfaces, or at least a portion thereof, of the vessel 24, specifically the pathway 26 of the vessel, as well as the conveyor system 34, for example the above mentioned screw auger, formed with or coated in the catalytic material, the generated syngas 32 can reacted and reformed with the catalytic material 33 as a catalyst, for example to increase the hydrogen content and/or methane number, at substantially in tandem or sequentially when the syngas 32 is being filtered by the at least one of the cellulosic material 22 and the biochar 30. This not only improves the cleanliness of the syngas 32 through but also improves the fuel gas quality thereof. Alternatively, the screw auger may be formed substantially or entirely from the catalytic material 33.

The heat generator 28 is one an electrical heater and a heat-exchanger and the released, or generated, syngas 32 is at least one of hydrogen, methane, carbon monoxide, and carbon dioxide. The heat-exchanger used may be an ablative heat-exchanger fueled by, for example, flue gas.

The syngas method 100 further comprises a step 130 of injecting the cellulosic material 22 into the pathway 26 of the vessel 24, by a displacement screw conveyor 38 or the like displacement system, prior to the step 110 of heating the cellulosic material 22 in the vessel 24. The syngas method 100 further comprises a step 132 of ejecting the biochar 30 from the vessel 24 in response to the syngas 32 been substantially discharged therefrom.

The step 116 of discharging the filtered syngas 32 from the vessel 24 comprises a step 140 of discharging the filtered syngas 32 to one of a downstream process 40 and a storage system 42, and a step 142 of generating at least one of heat energy and mechanical energy from the filtered syngas 32 by a gas engine as part of the downstream process 40.

The syngas system 20 comprises the vessel 24 comprising and defining the pathway 26 and the heat generator 28 in thermal communication with the pathway 26. Preferably, the syngas system 20 further comprises the conveyor system 34, the displacement system 36 and displacement screw conveyor 38. The syngas system 20 can further comprise at least one of installations or systems for performing the downstream process 40 and the storage system 42.

Preferably, the vessel 24 further comprises a first opening 50 for receiving the cellulosic material 22 into the vessel 24 to be heated to pyrolysis and a second opening 52 for the removal or discharge of the biochar 30 from the vessel 24. It is preferred that each of the first opening 50 and the second opening 52 has a door, lid, gate or access control system that is operable and adapted for substantially impeding escape of fluids, for example the syngas 32, from the vessel 24 when pressurized and for defining the pathway 26, in part. Discharge, or ejection, of the biochar 30 from the vessel 24 can be one or both of gravity assisted and mechanized using a displacement system similar to the displacement screw conveyor 38. In some implementations, the vessel 24 can comprise only one opening serving both the functions of the first opening 50 and the second opening 52 for introducing cellulosic material 22 and ejecting or removal of biochar 30 from the vessel. In such an implementation, the same displacement screw conveyor 38 or the like displacement system may be used for displacing the cellulosic material 22 into and for removal of biochar 30 from the vessel 24, through the opening.

As pressure is built up in the vessel 24 as a result of the generated syngas 32, the filtered syngas 32 may be discharged from the vessel 24 by way of the pressure in the vessel with or without the existence or use of the displacement system. The syngas 32 is preferably displaced substantially against the direction of flow of the cellulosic material 22 travelling along the pathway 28 during pyrolysis, or flash pyrolysis, to improve filtration thereof. Although this is preferred, the syngas 32 may additionally or alternatively be displaced substantially along or perpendicular to the direction of flow of the cellulosic material 22 travelling along the pathway 28.

Discharge of the filtered syngas 32 may be at one or both of the first opening 50 and the second opening 52. Additionally or alternatively, the filtered syngas 32 may be discharged through a port 53 defined by or formed with the vessel 24. The vessel 24 can further comprise a discharge valve 54, whether operated automatically by pressure relief or time-delay, remotely through wired or wireless control or manually through operating of the discharge valve 54, for controlling or metering discharge of the filtered syngas 32 from the vessel 24. When implemented, the discharge valve 54 is configured and disposed at one of the port 53, the first opening 50 and the second opening 52. The port 53 may be defined adjacent one of the first opening 50 and the second opening 52.

Aspects of particular embodiments of the present disclosure address at least one aspect, problem, limitation, and/or disadvantage associated with existing syngas generating approaches. While features, aspects, and/or advantages associated with certain embodiments have been described in the disclosure, other embodiments may also exhibit such features, aspects, and/or advantages, and not all embodiments need necessarily exhibit such features, aspects, and/or advantages to fall within the scope of the disclosure. It will be appreciated by a person of ordinary skill in the art that several of the above-disclosed structures, components, or alternatives thereof, can be desirably combined into alternative structures, components, and/or applications. In addition, various modifications, alterations, and/or improvements may be made to various embodiments that are disclosed by a person of ordinary skill in the art within the scope of the present disclosure, which is limited only by the following claims.

1. A method for generating syngas comprising:
heating cellulosic material in a vessel comprising a pathway and a heat generator in thermal communication with the pathway to thermally degenerate the cellulosic material by pyrolysis, the cellulosic material forming biochar and releasing syngas when undergoing pyrolysis;
displacing the generated syngas along the pathway to thereby filter the syngas through at least one of the cellulosic material and the biochar undergoing pyrolysis;
reacting at least a portion of the generated syngas with catalytic material presented along the pathway for reforming the at least a portion of the generated syngas being displaced along the pathway; and
discharging the filtered syngas from the vessel,
wherein the cellulosic material comprising at least one of woodchips, wood pellets, biomass and biowaste.

2. The method as in claim 1, the vessel comprising at least one tube for forming the pathway, the at least one tube being one of substantial and entirely formed from the catalytic material for exposing the generated syngas thereto during passage of the syngas through the pathway.

3. The method as in claim 1, the vessel comprising at least one tube for forming the pathway, the at least one tube being internally-coated with the catalytic material for exposing the generated syngas thereto during passage of the syngas through the pathway.

4. The method as in claim 1, the catalytic material being formed from at least one of Nickle (Ni), Molybdenum (Mo), Platinum (Pt), Ruthenium (Ru), Cobalt/Molybdenum (CoMo), Nickel/Molybdenum (NiMo) and Nickle Oxide (NiO) catalysts.

5. The method as in claim 1, the pathway comprising a closed-loop circuit for recirculating the syngas for filtering through at least one of the cellulosic material and the biochar.

6. The method as in claim 1, displacing the generated syngas along the pathway comprising:
displacing the cellulosic material along the pathway by a conveyor system for heating by the heat generator for forming the biochar, the conveyor system being one of a displacement screw conveyor and a gravity feed system.

7. The method as in claim 6, the conveyor system being a screw auger one of formed from and having the catalytic material coated thereon.

8. The method as in claim 1, displacing the generated syngas along the pathway comprising:
displacing the generated syngas by a displacement system along the pathway and substantially through the cellulosic material undergoing pyrolysis,
wherein the heat generator is one of an electrical heater; a heat-exchanger and an ablative heat-exchanger.

9. The method as in claim 1, further comprising:
injecting the cellulosic material into the pathway of the vessel by a displacement screw conveyor; and
ejecting the biochar from the vessel in response to the syngas being substantially discharged therefrom.

10. The method as in claim 1, discharging the filtered syngas from the vessel comprising:
discharging the filtered syngas from a port to one of a downstream process and a storage system,
wherein the port being defined by the vessel and configured for facilitating flow of the filtered syngas in a direction that is substantially against the flow of the cellulosic material along the pathway, and
wherein the syngas is at least one of hydrogen, methane, carbon monoxide, and carbon dioxide.

11. A system for generating syngas comprising:
a vessel comprising:
a pathway for heating cellulosic material therein; and
a heat generator in thermal communication with the pathway to thermally degenerate the cellulosic material by pyrolysis, the cellulosic material forming biochar and releasing syngas when undergoing pyrolysis,
wherein the pathway is shaped and adapted for displacing the generated syngas along the pathway to thereby filter the syngas through at least one of the cellulosic material and the biochar undergoing pyrolysis and the pathway having catalytic material presented therealong for reacting with at least a portion of the generated syngas to reform the at least a portion of the generated syngas being circulated along the pathway,
wherein the filtered syngas is dischargeable from the vessel, and
wherein the cellulosic material comprising at least one of woodchips, wood pellets, biomass and biowaste.

12. The system as in claim 11, the vessel comprising at least one tube for forming the pathway, the at least one tube being one of substantial and entirely formed from the catalytic material for exposing the generated syngas thereto during passage of the syngas through the pathway.

13. The system as in claim 11, the vessel comprising at least one tube for forming the pathway, the at least one tube being internally-coated with the catalytic material for exposing the generated syngas thereto during passage of the syngas through the circulatory pathway.

14. The system as in claim 11, the catalytic material being formed from at least one of Nickle (Ni), Molybdenum (Mo), Platinum (Pt), Ruthenium (Ru), Cobalt/Molybdenum (CoMo), Nickel/Molybdenum (NiMo) and Nickle Oxide (NiO) catalysts.

15. The system as in claim 11, the pathway comprising a closed-loop circuit for recirculating the syngas for filtering through at least one of the cellulosic material and the biochar.

16. The system as in claim 11, further comprising:
a conveyor system for displacing the cellulosic material along the pathway for heating by the heat generator for forming the biochar, the conveyor system being one of a displacement screw conveyor and a gravity feed system.

17. The system as in claim 16, the conveyor system being a screw auger one of formed from and having the catalytic material coated thereon.

18. The system as in claim 11, further comprising:
a displacement system for displacing the generated syngas along the pathway and substantially through the cellulosic material undergoing pyrolysis,
wherein the heat generator is one an electrical heater, a heat-exchanger; and an ablative heat exchanger.

19. The system as in claim 11, further comprising:
a displacement screw conveyor for injecting the cellulosic material into the pathway of the vessel by,
wherein the biochar is ejected from the vessel in response to the syngas been substantially discharged therefrom.

20. The system as in claim 11, the filtered syngas being discharged from a port to one of a downstream process and a storage system, the port being defined by the vessel and configured for facilitating flow of the filtered syngas in a direction that is substantially against the flow of the cellulosic material along the pathway,
wherein the syngas is at least one of hydrogen, methane, carbon monoxide, and carbon dioxide.
